(19) United States
(12) Patent Application Publication
(10) Pub. No.: US 2007/0268085 A1
(43) Pub. Date: Nov. 22, 2007

(54) Method and system for designing shielded interconnects

(75) Inventor: Kenneth W. Egan, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: X-EMI, Inc., Austin, TX (US)

(21) Appl. No.: 11/436,294

(22) Filed: May 18, 2006

(51) Int. Cl. H01P 3/00

(52) U.S. Cl. 333/4

(57) ABSTRACT

A method of determining characteristics for electromagnetic shielding for a signal interconnect is disclosed. The electromagnetic shielding is to comprise a shielding dielectric layer and a shielding conductive layer. The method includes determining a set of harmonic frequencies associated with an operating frequency of a signal to be transmitted via the interconnect, identifying a dielectric material based on a loss tangent of the dielectric material and the set of harmonic frequencies, determining an expected appreciable electromagnetic field generated by a transmission of the signal, and determining a maximum extent of the expected appreciable electromagnetic field from the interconnect. The method additionally includes determining a dimension for the shielding dielectric layer based on the maximum extent, simulating electromagnetic characteristics of the interconnect and the shielding dielectric layer based on the identified dielectric material and the dimension, and verifying an operation of the interconnect and the shielding dielectric layer.

### BACKGROUND

1. Field of the Invention

The present disclosure relates generally to electromagnetic interference and radiated emissions, and more particularly to electromagnetic and radiated emission reduction techniques.

2. Description of the Related Art

To maintain radiated electromagnetic interference (EMI) levels at a desired level, for governmental-standard compliance purposes or internal considerations, electronic system designers typically employ various EMI reduction techniques, such as slowing down the clock, controlling rising and falling edges of signals, utilizing spread spectrum clock generation (SSCG), or complex system shielding. While these EMI reduction techniques are effective to varying degrees, each also suffers attendant limitations. For example, complex system shielding requires the use of expensive conductive material to prevent emitted radiation from leaking outside of the shielded enclosure while also increasing the size and complexity of the system. These complex shields also increase heat accumulation inside the system, which can be exacerbated by reduced airflow or inadequate ventilation. Likewise, as the system speed often is proportional to the clock, slowing the clock for EMI reduction purposes reduces the effective speed of the system.

EMI emissions are related to their spectral energy content by the following formulas:

Radiated EMI=k*I*A*f² (EQ. 1)

Conducted EMI=k*I*A*f (EQ. 2)

where k represents a predetermined constant, I represents the loop current, A represents the loop area of the current I, and f represents the frequency of the signal. It can be seen that for a given trapezoidal waveform, the harmonics of said signal can create the largest emissions due to the quadratic effect of frequency. Further, in systems with differential signaling, non-homogeneities of the dielectric cause propagation velocity differences, which will cause radiation due to the mismatched electromagnetic fields propagating through the differential signal traces. Typically, these fields have field cancellation in a homogenous dielectric medium. EMI in interconnects is typically exasperated in interconnects due to a variety of factors, including impedance discontinuities in the connector interface, loss of local ground return path, and bends in the connectors themselves, which create high gradients of the EM field.

The EMI in interconnects typically can be reduced by potting the interconnect with a low loss tangent and low dielectric constant material and by providing a conductive metal shield structure that contains the emissions and provide a more robust ground. Complex metallic shielding structures typically increase costs, add weight, and rely heavily on proper grounding to minimize leakage through any gaps or seems in the shielding structure.

Accordingly, improved techniques for reducing EMI in interconnects would be advantageous.

### BRIEF DESCRIPTION OF THE DRAWINGS

The present disclosure may be better understood, and its numerous objects, features, and advantages made apparent to those skilled in the art by referencing the accompanying drawings. The use of the same reference symbols in different drawings indicates similar or identical items.

FIG. 1 is a diagram illustrating a top-view of an exemplary integrated circuit system utilizing EMI shielded traces in accordance with at least one embodiment of the present disclosure.

FIG. 2 is a diagram illustrating a cross-section of the system of FIG. 1 in accordance with at least one embodiment of the present disclosure.

FIG. 3 is a diagram illustrating an exemplary system utilizing an EMI shielded cable in accordance with at least one embodiment of the present disclosure.

FIG. 4 is a diagram illustrating a cross-section of the EMI shielded cable of FIG. 3 in accordance with at least one embodiment of the present disclosure.

FIG. 5 is a flow diagram illustrating an exemplary method for designing an EMI shielded interconnect in accordance with at least one embodiment of the present disclosure.

FIG. 6 is a diagram illustrating an exemplary EM field generated by the EMI shielded interconnect of FIG. 1 in accordance with at least one embodiment of the present disclosure.

FIG. 7 is a diagram illustrating an exemplary EM field generated by the EMI shielded cable of FIG. 3 in accordance with at least one embodiment of the present disclosure.

### DETAILED DESCRIPTION OF THE PREFERRED EMBODIMENTS

In accordance with one aspect of the present disclosure, a method of determining characteristics for electromagnetic shielding for a signal interconnect is disclosed. The electromagnetic shielding is to comprise a shielding dielectric layer and a shielding conductive layer. The method includes determining a set of harmonic frequencies associated with an operating frequency of a signal to be transmitted via the interconnect and identifying a dielectric material based on a loss tangent of the dielectric material and the set of harmonic frequencies. The method further includes determining an expected appreciable electromagnetic field generated by a transmission of a signal having the operating frequency via the interconnect and determining a maximum extent of the expected appreciable electromagnetic field from the interconnect. The method additionally includes determining a first dimension for the shielding dielectric layer based on the maximum extent. The method also includes simulating electromagnetic characteristics of the interconnect and the shielding dielectric layer based on the identified dielectric material and the first dimension for the shielding dielectric layer to generate first simulation results and verifying a first operation of the interconnect and the shielding dielectric layer based on the first simulation results.

In accordance with another aspect of the present disclosure, an electronic device includes a first dielectric layer, an interconnect disposed at a surface of the first dielectric layer, a conductive layer, and a second dielectric layer disposed between the interconnect and the second dielectric layer. A dimension of the second dielectric layer is based on a maximum extent of an expected appreciable electromagnetic field resulting from a transmission of a signal having an operating frequency via the interconnect.

In accordance with another aspect of the present disclosure, a signal cable includes a wire interconnect, a dielectric layer encapsulating a length of the conductive wire interconnect and a conductive layer encapsulating a length of the dielectric layer. A dimension of the dielectric layer is based on a maximum distance of an expected appreciable electromagnetic field resulting from a transmission of a signal having an operating frequency via the wire interconnect.

In accordance with yet another aspect of the present disclosure, a computer readable medium embodying a set of executable instructions is provided. The set of executable instructions includes instructions to determine a set of harmonic frequencies associated with an operating frequency of a signal to be transmitted via the interconnect and instructions to identify a dielectric material based on a loss tangent of the dielectric material and the set of harmonic frequencies. The set of instructions also includes instructions to determine an expected appreciable electromagnetic field generated by a transmission of a signal having the operating frequency via the interconnect and instructions to determine a maximum extent of the expected appreciable electromagnetic field from the interconnect. The set of instructions further includes instructions to determine a first dimension for the shielding dielectric layer based on the maximum extent. The set of instructions also includes instructions to simulate electromagnetic characteristics of the interconnect and the shielding dielectric layer based on the identified dielectric material and the first dimension for the shielding dielectric layer to generate first simulation results and instructions to verify a first operation of the interconnect and the shielding dielectric layer based on the first simulation results.

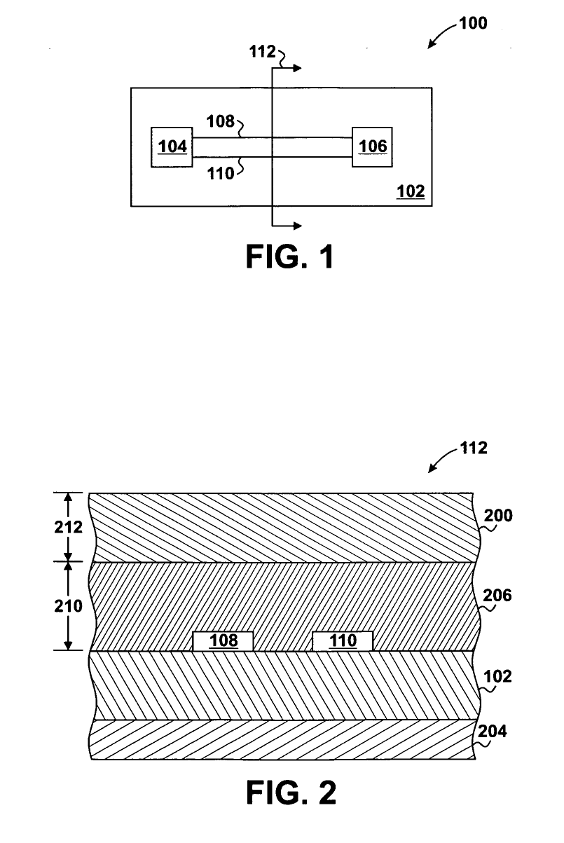

FIGS. 1-7 illustrate exemplary techniques for designing and manufacturing EMI shielded interconnects for electrical systems. In one embodiment, the electromagnetic properties of a designed interconnect without shielding is simulated based on expected characteristics of signals to be transmitted via the interconnect. Based on the simulation, the expected spectral energy signature of the interconnect, including the electromagnetic energy characteristics at harmonic frequencies, is determined. A dielectric material having a high loss tangent relative to the identified frequencies is selected for addition to the interconnect model. The simulation of the unshielded interconnect also is analyzed to identify the maximum extent (or distance) of appreciable EMI radiation from the interconnect. The interconnect model is updated to include a shielding dielectric layer that overlays the conductive interconnect, where a dimension (e.g., thickness or diameter) of the shielding dielectric layer is selected based on the identified maximum height of appreciable EMI radiation. The dimension of the shielding dielectric layer can be further refined by iterative simulation of an adjusted dimension of the shielding dielectric layer until a particular dimension for the shielding dielectric layer is verified as sufficient for the expected EM field. Thereafter, the original simulation or a subsequent simulation can be analyzed to determine a desired volumetric resistivity and a desired surface resistivity for a shielding conductive layer that is to overlay the interconnect and the shielding dielectric layer. A conductive material is selected based on the desired volumetric resistivity and desired surface resistivity, and the model of the interconnect is modified to include a shielding conductive layer having the identified conductive material that overlays the shielding dielectric layer. Successive simulation iterations on the shielded interconnect model then can be performed to further refine the dimension of the shielding conductive layer until sufficient EMI shielding characteristics are exhibited by the shielded interconnect model. In one embodiment, this process is automated in simulation software. In another embodiment, a user of the simulation software inputs certain values defining the characteristics of model, performs the simulation using, for example, commercially-available electromagnetic field solver software, and then refines the values based on an assessment of the simulation results.

The term “interconnect,” as used herein, refers to any of a variety of conductive structures used to transmit electronic signaling. Examples of interconnects include, but are not limited to, circuit traces, vias, backplanes, cabling, busses, and the like. For ease of discussion, the exemplary techniques are described herein in the context of a differential signaling-based circuit trace and in the context of a differential-signaling based cable. However, those skill in the art, using the guidelines provided herein, can implement the disclosed techniques for any of a variety of interconnect types.

Referring to FIG. 1, an exemplary system utilizing a EMI shielded trace-type interconnect is illustrated in accordance with at least one embodiment of the present disclosure. The system 100 includes a substrate 102 and circuit components 104 and 106 disposed at the substrate 102. The circuit components 104 and 106 are connected via shielded traces 108 and 110, which together form a differential signaling path between the circuit component 104 and 106. As described in greater detail with reference to the cross-section 112 (FIG. 2) of the system 100, the shielded traces 108 and 110 each include a conductive trace overlaid by a shielding dielectric layer and a shielding conductive layer, where one or more dimensions and the material type of the shielding dielectric layer are based on an expected EMI field emanating from the conductive traces 108 and 110, the expected EMI field determined based on EM field simulations of the traces in view of the characteristics of the signaling expected to be transmitted over the traces. Likewise, the material type, as well as one or more dimensions, of the shielding conductive layer is based on the expected EMI field.

Referring to FIG. 2, a diagram illustrating an exemplary cross-section 112 of the system 100 is illustrated in accordance with at least one embodiment of the present disclosure. In the depicted example, the system 100 includes the substrate 102 overlying the ground plane 204. The conductive traces 108 and 110 are disposed substantially in parallel at a surface of the substrate 102. The system 100 further includes a shielding dielectric layer 206 overlying the conductive traces 108 and 110 and the surface of the substrate 102, and a shielding conductive layer 208 overlying the shielding dielectric layer 206. The shielding conductive layer 208 is electrically connected to the ground plane or other voltage reference via, e.g., one or more vias (not shown). The shielding dielectric layer 206 and the shielding conductive layer 208 can be co-extensive, or one layer may have a greater area than the other. Further, although the embodiment of FIG. 2 illustrates the shielding dielectric layer 206 and the shielding conductive layer 208 in direct contact, in other embodiments, one or more intervening layers may be disposed between the layer 206 and the layer 208. The system 100 further can include additional material layers, such as a dielectric layer that overlays the shielding conductive layer 208 so as to electrically isolate the shielding dielectric layer 208. These additional layers may be disposed between any of the layers illustrated in FIG. 2

In at least one embodiment, the thickness 210 (one embodiment of a dimension) of the shielding dielectric layer 206 and the composition of its material, are based on the maximum extent of appreciable EM radiation expected to be generated by the traces 108 and 110 when transmitting signals having identified characteristics, such as a particular frequency, waveform type, and the like. Further, in one embodiment, the thickness 212 of the shielding conductive layer 208 and the composition of its material are based on the EMI attenuation of the conductive material per unit of dimension, such as the attenuation per millimeter of conductive material. Exemplary dielectric materials that can be employed in the shielding dielectric layer 206 include, but are not limited to, FR-grade epoxy fiberglass, Teflon, GTEK, polyethylene, polycarbonate, polysulfone, polyolefin, ABS, PTE, liquid crystal polymer, polyetherimide, nylon, styrene, polyphenylene sulfide, polyethersulfone, polyetherketone, polyphthalamide, polyimide, polytrimethylene terephthalate, and the like. Exemplary conductive materials that can be employed in the shielding conductive layer 208 include, but are not limited to, conductive plastics or conductive polymers, such as a dielectric material with a stainless steel wool filler, a carbon powder filler, carbon nanotubes, or nickel, copper, or silver additives.

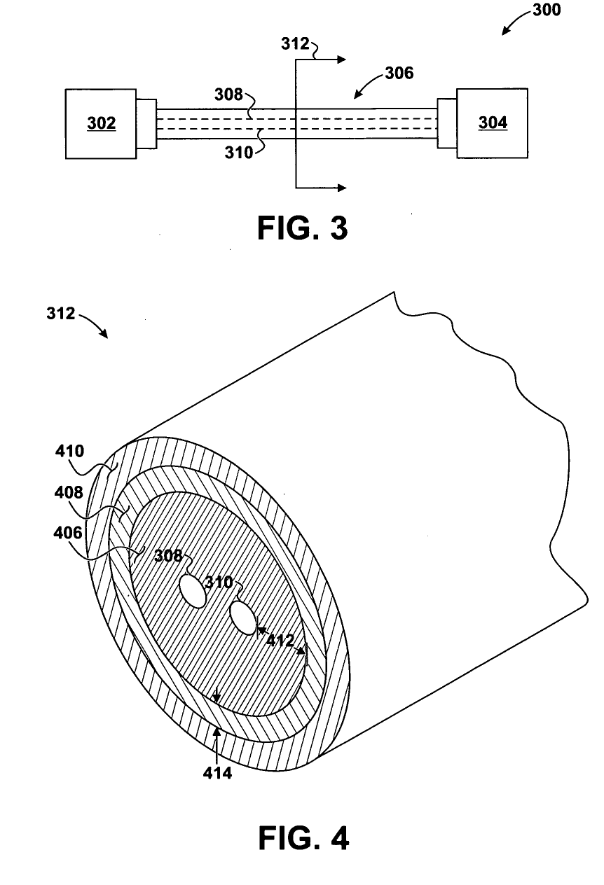

Referring to FIG. 3, an exemplary system 300 employing a shielded cable is illustrated in accordance with at least one embodiment of the present disclosure. The system 300 includes system components 302 and 304 connected via a shielded cable 306. In the illustrated embodiment, the shielded cable 306 includes conductive wires 308 and 310 for differential signal transmission between the components 302 and 304. The conductive wires 308 and 310, in one embodiment, are a twisted pair.

As described in greater detail with reference to the cross-section 312 (FIG. 4) of the system 300, the shielded cable 306 includes a dielectric core layer (one embodiment of a shielding dielectric layer), through which the conductive wires 308 and 310 extend. The shielded cable 306 further includes a shielding conductive layer overlaying or otherwise encapsulating the dielectric core layer, where the dimensions, material types, or combinations thereof, of the shielding dielectric core layer and the shielding conductive layer are based on an expected EMI field emanating from the conductive wires 308 and 310. As with the conductive traces 108 and 110 of FIG. 1, the expected EMI field of the conductive wires 308 and 310 can be determined based on EM field simulations of a modeling of the conductive wires 308 and 310 in view of the characteristics of the signaling expected to be transmitted via the cable 306.

Referring to FIG. 4, a diagram illustrating an exemplary cross-section 312 of the shielded cable 306 of FIG. 3 is illustrated in accordance with at least one embodiment of the present disclosure. In the depicted example, the shielded cable 306 includes a dielectric core layer 406 through which the conductive wires 308 and 310 extend. Encapsulating the dielectric core layer 406 along at least a substantial portion of the length of the dielectric core layer 406 is a shielding conductive layer 408. Although FIG. 4 illustrates an embodiment wherein the shielding conductive layer 408 is in direct contact with the dielectric core layer 406, in an alternate embodiment one or more intervening layers may be disposed between the dielectric core layer 406 and the shielding conductive layer 408.

In at least one embodiment, the diameter(s) (one embodiment of a dimension) of the shielding dielectric core layer 406 and the composition of its material, are based on the maximum extent of appreciable EM radiation expected to be generated by the conductive wires 308 and 310 when transmitting signals having identified characteristics, such as a particular frequency, waveform type, and the like. For cables and similarly formed connectors, the “thickness” of the shielding dielectric core layer 406 refers to the minimum thickness 418 of the dielectric core layer 406 between either of the conductive wires 308 and 310 and the outer surface of the dielectric core layer 406. Similarly, in one embodiment, the thickness 214 of the shielding conductive layer 208 and the composition of its material are based on the electromagnetic attenuation of the conductive material per unit of dimension (e.g., per millimeter).

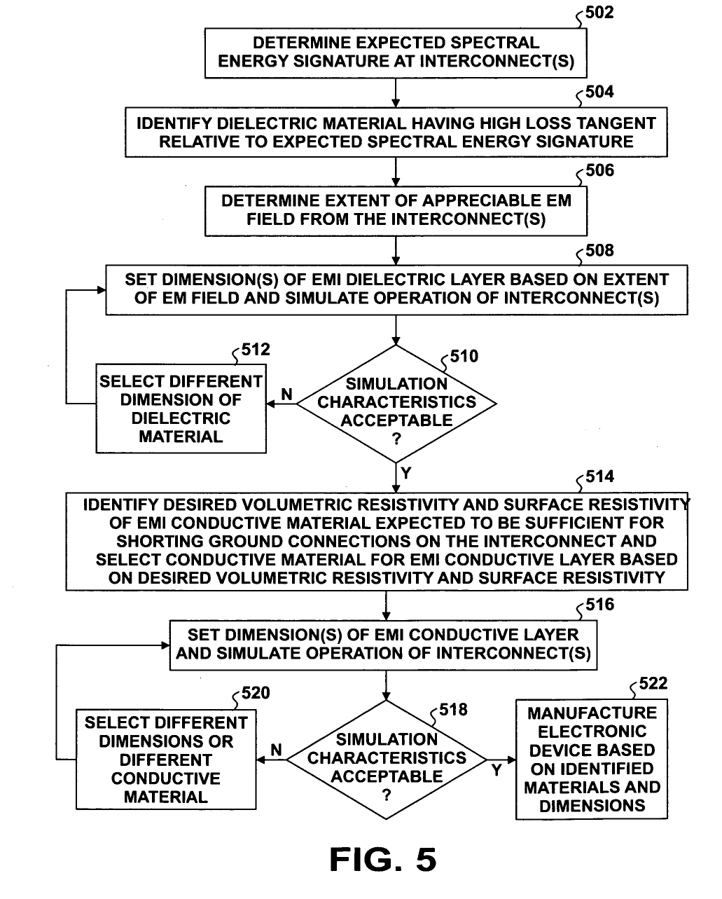

Referring to FIGS. 5-7, an exemplary method 500 for designing a shielded interconnect for reduced EMI is illustrated in accordance with at least one embodiment of the present disclosure. The method 500 includes generating a model of an interconnect to be shielded and determining an expected spectral energy signature of the model based on a simulation of the model in view of the expected signaling to be transmitted via the modeled interconnect at block 502. In this instance, the model does not yet include the shielding layers. The modeling and simulation can be performed using any of a variety of commercially-available EM field solvers, such as, for example, Ansoft HFSS, CST Microwave Studio, Flomerics, and the like. The expected spectral energy signature, in one embodiment, includes information regarding the spectral energy expected to be emitted by the interconnect, such as the spectral energy emitted at particular harmonic frequencies and the phase dispersion and loss mechanisms at these frequencies. To illustrate, for a system with a 2500 megabit-per-second (Mbps) signaling rate and a trapezoidal waveform, the major harmonics of interest typically include 250 megahertz (MHz), 750 MHz, 1250 MHz, 1750 MHz, and 1750 MHz. Because leading edge collapse is one significant factor that results in closing of the statistical timing “eye,” the expected spectral energy signature can include information regarding the phase dispersion and loss mechanisms at the third and fifth harmonics, as they are major contributors to the edge rate of the signaling.

At block 504, the method 500 includes identifying a dielectric material for use as a shielding layer based on the expected spectral energy signature determined at block 502. In one embodiment, the dielectric material is selected based on its loss tangent properties relative to the major frequencies of interest as identified in the expected spectral energy signature. In this instance, it is desirable to select the dielectric material having the highest loss tangent for the major frequencies of interest, all else being equal. In one embodiment, the dielectric material is selected by a user who consults material properties sheets of various dielectric materials to determine their loss tangent properties for the major frequencies of interest and then selects a dielectric material accordingly. In an alternate embodiment, the identification of the suitable dielectric material is automated by the simulation software. To illustrate, the simulation software may have access to a database storing information about various dielectric materials, including their loss tangents at particular frequencies, their costs, evaluations of their suitability in certain operating environments, and the like. The simulation software then may take this information into account in selecting a dielectric material having a sufficient loss tangent for the major frequencies of interest.

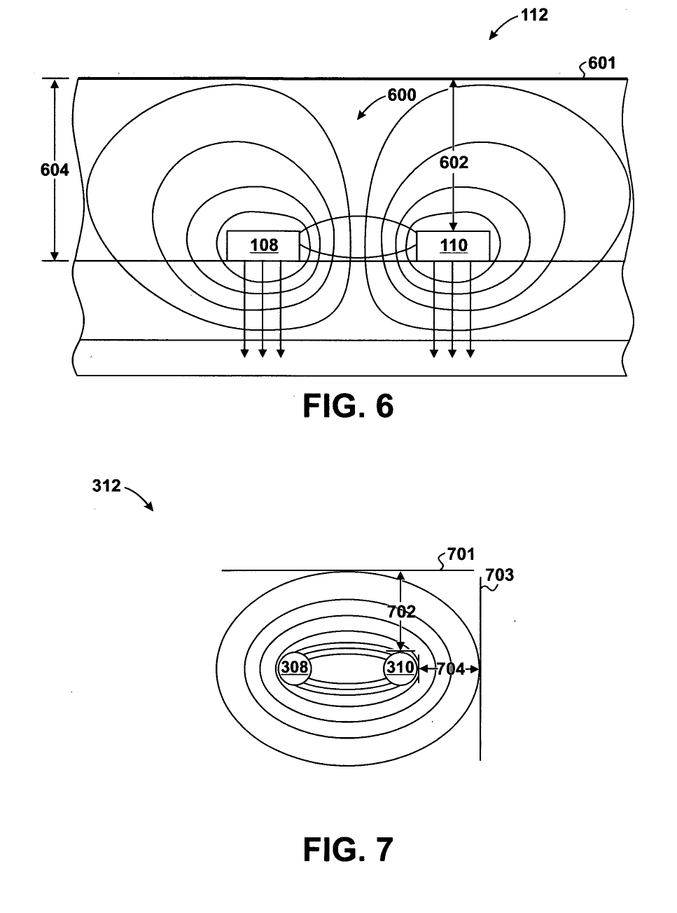

At block 506, the method 500 includes determining the maximum distance or extent from the interconnect that appreciable EM radiation is expected to be present based on a simulation of the modeled interconnect in view of the expected signaling characteristics. The term “appreciable EM radiation,” as used herein, refers to EM radiation above a predetermined threshold that can be set by a user or the simulation software. For example, if the peak allowable energy at 500 MHz is 36 dBuV, then with margin the design target may be selected to be 30 dBuV. For example, FIG. 6 illustrates an exemplary EM field 600 generated by the cross-section 112 representing unshielded traces 108 and 110 of the system 100 (FIG. 2). In the depicted example, plane 601 represents the point at which the strength of the EM field 600 falls below a predetermined threshold, and therefore represents the maximum extent of appreciable EM radiation by the EM field 600. Accordingly, in one embodiment, the maximum distance of appreciable EM radiation can be measured as the distance 602 between the top surfaces of the traces 108 and 110 and the plane 601. In an alternate embodiment, the maximum distance of appreciable EM radiation can be measured as the distance 604 between the bottom surfaces of the traces 108 and 110 and the plane 601. Other distances, such as the distance between a midpoint of the cross-sections of the traces 108 and 110 and the plane 601, also may be used as a measure of the maximum extent of appreciable EM radiation.

As another example, FIG. 7 illustrates an exemplary EM field 700 generated by the cross-section 312 representing the conductive wires 308 and 310 of the cable 306 (FIG. 3). In the depicted example, planes 701 and 703 represent the points in the abscissa and ordinate axes, respectively, at which the strength of the EM field 700 falls below a predetermined threshold. Accordingly, the maximum extent of appreciable radiation along the ordinate axis can be measured as, for example, the distance 702 from the surface (or, alternately, the middle) of one of the conductive wires 308 and 310 to the plane 701, while the maximum extent of appreciable radiation along the abscissa axis can be measured as, for example, the distance 704 from the surface (or, alternately, the middle) of one of the conductive wires 308 and 310 to the plane 703. Other distances also may be used as a measure of the maximum extent of appreciable EM radiation.

At block 508, the method 500 comprises modifying the interconnect model to include a shielding dielectric layer that overlies or encapsulates the interconnect, where the shielding dielectric layer comprises the dielectric material identified at block 504. Further, one or more dimensions of the shielding dielectric layer are configured in the model based on the maximum extent of appreciable EMI radiation identified at block 506. To illustrate, for trace-type interconnects as in FIGS. 1 and 2, the dimensions of the shielding dielectric layer configured based on the maximum extent of appreciable EMI radiation include the thickness of the shielding dielectric layer. As another example, for a cable-type interconnect as in FIGS. 3 and 4, the dimensions of the shielding dielectric layer based on the maximum extent of appreciable EMI radiation include a diameter of the dielectric core of the cable (if the core is substantially cylindrical), or a major axis and a minor axis of the dielectric core of the cable (if the cross section of the core is elliptical).

In at least one embodiment, the dimensions of the shielding dielectric layer for the model are configured so that they extend to at least the maximum extent of appreciable EMI radiation, thereby containing the appreciable EMI radiation within the shielding dielectric layer. To illustrate, assume that appreciable EMI radiation extends up to 90 mils (0.090″) beyond the edges of the traces 108 and 110 of the interconnects of system 100 (FIG. 1). In this example, the thickness of the shielding dielectric layer 206 can be selected to be, for example, 0.092″ mm so that appreciable EMI radiation is not expected to extend past the top surface of the shielding dielectric layer 206.

The method 500 further includes simulating the operation of the interconnect based on the modified model that includes the shielding dielectric layer having the specified dimension(s) and material at block 508. At block 510, the method 500 includes analyzing the resulting simulation characteristics to verify that the behavior of the model is acceptable. In one embodiment, this analysis includes verifying that the appreciable EMI radiation is substantially contained in the modeled shielding dielectric layer. In the event that the simulation characteristics reveal that the model exhibits unacceptable operating behavior, the method 500 includes selecting different characteristics for the shielding dielectric layer at block 512 and performing another simulation and analysis with the updated model. The characteristics that are changed can include, for example, the dielectric material, one or more dimensions of the shielding dielectric layer, or both. Thus, through successive iterations of adjusting the model and simulating the adjusted model, a refined shielding dielectric layer can be identified with more optimal spectral energy characteristics.

Once the final dimensions and material type of the shielding dielectric layer have been identified for the model, the method 500 includes determining one or more conductive materials for use for the shielding conductive layer for the interconnect at block 514. In one embodiment, the conductive material used for the shielding conductive layer is selected based on its volumetric resistivity and surface resistivity so as to provide effective containment of any EMI radiation that extends past the shielding dielectric layer by shorting any ground connections. In this instance, the simulations results are analyzed to identify the peak EMI exhibited by the model (typically indicated in units of dBuV (decibel microvolts)), and then correlating the identified peak EMI to the resistivity/dBuV attenuation characteristics exhibited by various conductive materials, whereby the conductive material having the greatest attenuation is selected, all else being equal. As with the dielectric material, a user can assess the simulation results and the material properties sheets for various conductive materials and select an appropriate conductive material accordingly, or the selection of a suitable conductive material may be automated by the simulation software based on a database of information regarding various conductive materials, including, for example, costs, operating environment characteristics, resistivity values, and the like.

After determining the conductive material to be used for the shielding conductive layer of the model, block 516 of method 500 includes selecting the dimensions (e.g., thickness) for the shielding conductive layer and configuring the model to include the shielding conductive layer with the indicated dimensions and conductive material(s). It will be appreciated that the dBuV attenuation of the conductive material of the shielding conductive layer is dependent on the thickness of the conductive material. Accordingly, the thickness or other dimension of the shielding conductive layer can be initially selected based on the peak EMI and the desired attenuation. Block 516 further includes performing a simulation of the modified model based on the added shielding conductive layer. At block 518, the method 500 includes analyzing the simulation results to verify whether the expected operation of the shielded interconnect is acceptable. In one embodiment, the model of the shielded interconnect is verified as acceptable when the EMI radiation detected outside of the shielded interconnect is below a certain threshold and when the simulation results indicate that a transmitted signal is complies with certain expectations, such as a maximum phase dispersion, meets target interconnect impedance or target thermal conductivity.

If the analysis indicates that the operation of the shielded interconnect is unacceptable, at block 520 the dimensions or conductive material(s) of the shielded conductive layer of the model are modified and the simulation is performed and analyzed at blocks 516 and 518 in an iterative approach until an acceptable model is identified. Once identified, further design on other aspects of the electronic device design may be performed and the design may be utilized to manufacture electronic devices at block 522.

A user can implement the method 500 described above with assistance from EM simulation software. To illustrate, the user can interact with the simulation software to build the model and perform the simulations, but the selection of materials and dimensions for the shielding layers are determined by the user. Alternately, the method 500 can be implemented largely by the simulation software, whereby the user provides configures the initial model of the unshielded interconnect and provides certain characteristics and constraints, such as cost and device size considerations, and the simulation software then determines an optimal model for the interconnect with the shielding layers.

Accordingly, the various functions and components in the present disclosure may be implemented using an information handling machine such as a data processor, or a plurality of processing devices. Such a data processor may be a microprocessor, microcontroller, microcomputer, digital signal processor, state machine, logic circuitry, and/or any device that manipulates digital information based on operational instruction, or in a predefined manner. Generally, the various functions, and systems represented by block diagrams are readily implemented by one of ordinary skill in the art using one or more of the implementation techniques listed herein.

When a data processor for issuing instructions is used, the instruction may be stored in memory. Such a memory may be a single memory device or a plurality of memory devices. Such a memory device may be read-only memory device, random access memory device, magnetic tape memory, floppy disk memory, hard drive memory, external tape, and/or any device that stores digital information. Note that when the data processor implements one or more of its functions via a state machine or logic circuitry, the memory storing the corresponding instructions may be embedded within the circuitry that includes a state machine and/or logic circuitry, or it may be unnecessary because the function is performed using combinational logic. Such an information handling machine may be a system, or part of a system, such as a computer, a personal digital assistant (PDA), a hand held computing device, a cable set-top box, an Internet capable device, such as a cellular phone, and the like.

What is claimed is:

1. A method of determining characteristics for electromagnetic shielding for a signal interconnect, the electromagnetic shielding to comprise a shielding dielectric layer and a shielding conductive layer, the method comprising:
determining a set of harmonic frequencies associated with an operating frequency of a signal to be transmitted via the interconnect;
identifying a dielectric material based on a loss tangent of the dielectric material and the set of harmonic frequencies;
determining an expected appreciable electromagnetic field generated by a transmission of a signal having the operating frequency via the interconnect;
determining a maximum extent of the expected appreciable electromagnetic field I from the interconnect;
determining a first dimension for the shielding dielectric layer based on the maximum extent;
simulating electromagnetic characteristics of the interconnect and the shielding dielectric layer based on the identified dielectric material and the first dimension for the shielding dielectric layer to generate first simulation results; and
verifying a first operation of the interconnect and the shielding dielectric layer based on the first simulation results.

2. The method of claim 1, wherein:
verifying the first operation comprises identifying the first operation of the interconnect as unacceptable based on the first simulation results; and
the method further comprises:
determining a second dimension for the shielding dielectric layer based on the first simulation results;
simulating electromagnetic characteristics of the interconnect and the shielding dielectric layer based on the identified dielectric material and the second dimension for the shielding dielectric layer to generate second simulation results;
verifying a second operation of the interconnect and the shielding dielectric layer based on the second simulation results.

3. The method of claim 1, wherein verifying the first operation comprises identifying the first operation of the interconnect as acceptable based on the first simulation results.

4. The method of claim 3, further comprising:
identify a desired volumetric resistivity and surface resistivity for the shielding conductive layer based on an expected peak electromagnetic interference exhibited by the first simulation results; and
identifying a conductive material for the shielding conductive layer based on the desired volumetric resistivity and surface resistivity;
determining a second dimension for the shielding conductive layer based on an electromagnetic attenuation of the conductive material;
simulating electromagnetic characteristics of the interconnect, the shielding dielectric layer and the shielding conductive layer based on the identified dielectric material and the first dimension for the shielding dielectric layer, and the identified conductive material and the second dimension for the shielding conductive layer to generate second simulation results; and
verifying a second operation of the interconnect, the shielding dielectric layer, and the shielding conductive layer based on the second simulation results.

5. The method of claim 4, wherein:
verifying the second operation comprises identifying the second operation of the interconnect as unacceptable based on the second simulation results; and
the method further comprises:
determining a third dimension for the shielding conductive layer based on the second simulation results;
simulating electromagnetic characteristics of the interconnect, the shielding dielectric layer and the shielding conductive layer based on the identified dielectric material and the first dimension for the shielding dielectric layer and based on the identified conductive material and the third dimension for the shielding conductive layer to generate third simulation results; and
verifying a third operation of the interconnect, the shielding dielectric layer, and the shielding conductive layer based on the third simulation results.

6. The method of claim 4, wherein verifying the second operation comprises identifying the second operation as acceptable based on the second simulation results.

7. The method of claim 6, wherein identifying the second operation as acceptable comprises determining a simulated impedance of the interconnect is below a maximum impedance threshold.

8. The method of claim 6, further comprising manufacturing a device comprising the interconnect, the shielding dielectric layer and the shielding conductive layer based on the first dimension and identified dielectric material for the shielding dielectric layer and the second dimension and identified conductive material for the shielding conductive layer.

9. The method of claim 1, wherein identifying a dielectric material comprises selecting a dielectric material based on an expected attenuation of one or more harmonic frequencies of the set of harmonic frequencies by the dielectric material.

10. The method of claim 1, wherein verifying the first operation comprises at least one of verifying a maximum impedance for the interconnect or verifying a maximum phase dispersion for the interconnect.

11. The method of claim 1, wherein the interconnect comprises a trace of an integrated circuit and the first dimension of the shielding dielectric layer comprises a thickness of the shielding dielectric layer.

12. The method of claim 1, wherein the interconnect comprises a wire of a cable and the first dimension of the shielding dielectric layer comprises a diameter of the shielding dielectric layer.

13. An electronic device comprising:
a first dielectric layer;
an interconnect disposed at a surface of the first dielectric layer;
a conductive layer;
a second dielectric layer disposed between the interconnect and the second dielectric layer;
wherein a dimension of the second dielectric layer is based on a maximum extent of an expected appreciable electromagnetic field resulting from a transmission of a signal having an operating frequency via the interconnect.

14. The electronic device of claim 13, wherein a dielectric material of the second dielectric layer is based on a tangent loss of the dielectric material and a set of harmonic frequencies associated with the operating frequency.

15. The electronic device of claim 13, wherein a conductive material of the conductive layer is based on an identified volumetric resistivity and surface resistivity.

16. A signal cable comprising:
a wire interconnect;
a dielectric layer encapsulating a length of the conductive wire interconnect;
a conductive layer encapsulating a length of the dielectric layer; and
wherein a dimension of the dielectric layer is based on a maximum distance of an expected appreciable electromagnetic field resulting from a transmission of a signal having an operating frequency via the wire interconnect.

17. The signal cable of claim 16, wherein a dielectric material of the dielectric layer is based on a tangent loss of the dielectric material and a set of harmonic frequencies associated with the operating frequency.

18. The signal cable of claim 16, wherein a conductive material of the conductive layer is based on an identified volumetric resistivity and surface resistivity.

19. A computer readable medium embodying a set of executable instructions for determining characteristics for electromagnetic shielding for a signal, interconnect, the electromagnetic shielding to comprise a shielding dielectric layer and a shielding conductive layer, the set of executable instructions comprising:
instructions to determine a set of harmonic frequencies associated with an operating frequency of a signal to be transmitted via the interconnect;
instructions to identify a dielectric material based on a loss tangent of the dielectric material and the set of harmonic frequencies;
instructions to determine an expected appreciable electromagnetic field generated by a transmission of a signal having the operating frequency via the interconnect;
instructions to determine a maximum extent of the expected appreciable electromagnetic field from the interconnect;
instructions to determine a first dimension for the shielding dielectric layer based on the maximum extent;
instructions to simulate electromagnetic characteristics of the interconnect and the shielding dielectric layer based on the identified dielectric material and the first dimension for the shielding dielectric layer to generate first simulation results; and
instructions to verify a first operation of the interconnect and the shielding dielectric layer based on the first simulation results.

20. The computer readable medium of claim 19, the set of executable instructions further comprising:
instructions to identify a desired volumetric resistivity and surface resistivity for the shielding conductive layer based on an expected peak electromagnetic interference exhibited by the first simulation results; and
instructions to identify a conductive material for the shielding conductive layer based on the desired volumetric resistivity and surface resistivity;
instructions to determine a second dimension for the shielding conductive layer based on an electromagnetic attenuation of the conductive material;
instructions to simulate electromagnetic characteristics of the interconnect, the shielding dielectric layer and the shielding conductive layer based on the identified dielectric material and the first dimension for the shielding dielectric layer, and the identified conductive material and the second dimension for the shielding conductive layer to generate second simulation results; and
instructions to verify a second operation of the interconnect, the shielding dielectric layer, and the shielding conductive layer based on the second simulation results.

21. The computer readable medium of claim 19, wherein the interconnect comprises a trace of an integrated circuit and the first dimension of the shielding dielectric layer comprises a thickness of the shielding dielectric layer.

22. The computer readable medium of claim 19, wherein the interconnect comprises a wire of a cable and the first dimension of the shielding dielectric layer comprises a diameter of the shielding dielectric layer.
